(19) United States
(12) Patent Application Publication
(10) Pub. No.: US 2013/0050416 A1
(43) Pub. Date: Feb. 28, 2013

(54) VIDEO PROCESSING APPARATUS AND VIDEO PROCESSING METHOD

(71) Applicants: Masao Iwasaki, Tokyo (JP); Kiyoshi Hoshino, Tokyo (JP); Shinzo Matsubara, Tokyo (JP); Yutaka Irie, Yokohama-Shi (JP); Toshihiro Morohoshi, Kawasaki-Shi (JP)

(72) Inventors: Masao Iwasaki, Tokyo (JP); Kiyoshi Hoshino, Tokyo (JP); Shinzo Matsubara, Tokyo (JP); Yutaka Irie, Yokohama-Shi (JP); Toshihiro Morohoshi, Kawasaki-Shi (JP)

(73) Assignee: KABUSHIKI KAISHA TOSHIBA, Tokyo (JP)

(21) Appl. No.: 13/402,563

(22) Filed: Feb. 22, 2012

(30) Foreign Application Priority Data
Aug. 31, 2011 (JP) 2011-189496

(51) Int. Cl. H04N 13/00

(52) U.S. Cl. 348/43; 348/E13.062

(57) ABSTRACT

According to one embodiment, a video processing apparatus includes a receiver that decodes an encoded input video signal and generates a baseband video signal, a display manner selector that selects one display manner from plural display manners including a stereo imaging manner and an integral imaging manner, and a parallax image converter that converts, when the stereo imaging manner is selected by the display manner selector, the baseband video signal into two parallax image signals for the left eye and the right eye and converts, when the integral imaging manner is selected by the display manner selector, the baseband video signal into three or more parallax image signals.

### CROSS-REFERENCE TO RELATED APPLICATIONS

This application is based upon and claims the benefit of priority from the prior Japanese Patent Application No. 2011-189496, filed on Aug. 31, 2011, the entire contents of which are incorporated herein by reference.

### FIELD

Embodiments described herein relate generally to a video processing apparatus and a video processing method.

### BACKGROUND

In recent years, a stereoscopic video display apparatus (a so-called autostereoscopic 3D television) that enables a viewer to see a stereoscopic video with naked eyes without using special glasses is becoming widely used. The stereoscopic video display apparatus displays plural images from different viewpoints. If the position of the viewer is appropriate, since the viewer sees different parallax images with his left eye and his right eye, the viewer can stereoscopically recognize a video.

Among stereoscopic video contents (3D contents), in normal 3D contents such as frame packing (FP), side-by-side (SBS), and top-and-bottom (TAB), two parallax videos for the left eye and the right eye are included. When 2D video content is viewed as a stereoscopic video, after plural parallax images (e.g., three or more parallaxes) are generated by 2D to 3D conversion to convert a two-dimensional video into a stereoscopic video, the stereoscopic video is displayed on a liquid crystal panel.

In a stereoscopic video including two parallax images for the left eye and the right eye, a viewer can feel a stereoscopic effect and a sense of depth large. However, a range in which the stereoscopic video is stereographically seen (a viewing area) is small. On the other hand, a stereoscopic video including three or more parallax images is inferior in a stereoscopic effect. In this way, the stereoscopic effect of a stereoscopic video and the extent of a viewing area are in a trade-off relation.

### BRIEF DESCRIPTION OF THE DRAWINGS

FIG. 1 is an external view of a video processing apparatus 100 according to an embodiment;

FIG. 2 is a block diagram showing a schematic configuration of the video processing apparatus 100 according to the embodiment;

FIG. 3 is a diagram of a part of a liquid crystal panel 1 and a lenticular lens 2 viewed from above;

FIG. 4 is a top view showing an example of plural viewing areas 21 in a view area P of the video processing apparatus;

FIG. 5 is a block diagram showing a schematic configuration of a video processing apparatus 100′ according to a modification;

FIG. 6 is a flowchart for explaining a video processing method according to a first embodiment;

FIG. 7 is a flowchart for explaining a video processing method according to a first modification of the first embodiment;

FIG. 8 is a flowchart for explaining a video processing method according to a second modification of the first embodiment; and

FIG. 9 is a flowchart for explaining a video processing method according to a second embodiment.

### DETAILED DESCRIPTION

According to one embodiment, a video processing apparatus includes a receiver that decodes an encoded input video signal and generates a baseband video signal, a display manner selector that selects one display manner from plural display manners including a stereo imaging manner and an integral imaging manner, and a parallax image converter that converts, when the stereo imaging manner is selected by the display manner selector, the baseband video signal into two parallax image signals for the left eye and the right eye and converts, when the integral imaging manner is selected by the display manner selector, the baseband video signal into three or more parallax image signals.

Embodiments will now be explained with reference to the accompanying drawings.

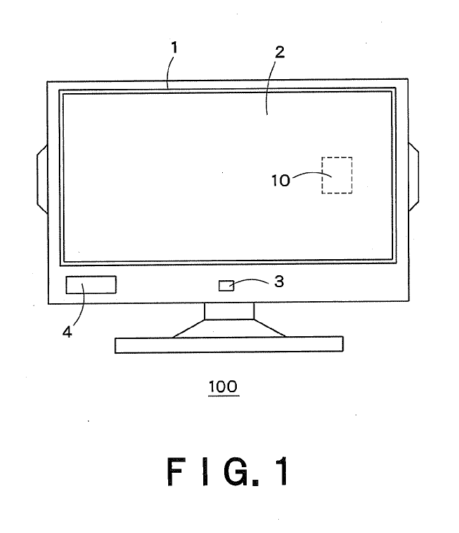

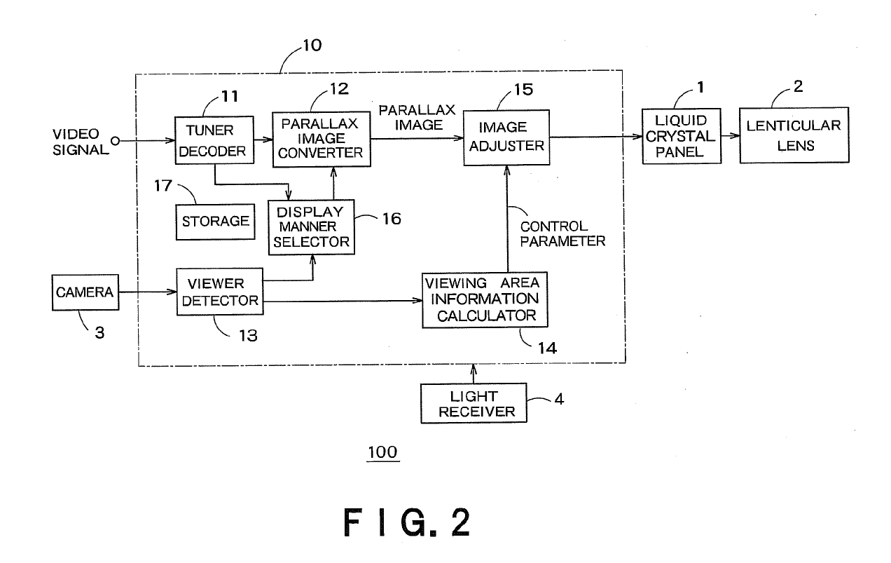

FIG. 1 is an external view of a video display apparatus 100 according to an embodiment. FIG. 2 is a block diagram showing a schematic configuration of the video display apparatus 100. The video display apparatus 100 includes a liquid crystal panel 1, a lenticular lens 2, a camera 3, a light receiver 4, and a controller 10.

The liquid crystal panel (a display) 1 displays plural parallax images that a viewer present in a viewing area can observe as a stereoscopic video. The liquid crystal panel 1 is, for example a 55-inch size panel. 11520 (=1280*9) pixels are arranged in the horizontal direction and 720 pixels are arranged in the vertical direction. In each of the pixels, three sub-pixels, i.e., an R sub-pixel, a G sub-pixel, and a B sub-pixel are formed in the vertical direction. Light is irradiated on the liquid crystal panel 1 from a backlight device (not shown) provided in the back. The pixels transmit light having luminance corresponding to a parallax image signal (explained later) supplied from the controller 10.

The lenticular lens (an apertural area controller) 2 outputs the plural parallax images displayed on the liquid crystal panel 1 (the display) in a predetermined direction. The lenticular lens 2 includes plural convex portions arranged along the horizontal direction of the liquid crystal panel 1. The number of the convex portions is 1/9 of the number of pixels in the horizontal direction of the liquid crystal panel 1. The lenticular lens 2 is stuck to the surface of the liquid crystal panel 1 such that one convex portion corresponds to nine pixels arranged in the horizontal direction. The light transmitted through the pixels is output, with directivity, in a specific direction from near the vertex of the convex portion.

The liquid crystal panel 1 according to this embodiment can display a stereoscopic video in an integral imaging manner of three or more parallaxes or a stereo imaging manner. Besides, the liquid crystal panel 1 can also display a normal two-dimensional video.

In the following explanation, an example in which nine pixels are provided to correspond to the convex portions of the liquid crystal panel 1 and an integral imaging manner of nine parallaxes can be adopted is explained. In the integral imaging manner, first to ninth parallax images are respectively displayed on the nine pixels corresponding to the convex portions. The first to ninth parallax images are images of a subject seen respectively from nine viewpoints arranged along the horizontal direction of the liquid crystal panel 1. The viewer can stereoscopically view a video by seeing one parallax image among the first to ninth parallax images with his left eye and seeing another one parallax image with his right eye. According to the integral imaging manner, a viewing area can be expanded as the number of parallaxes is increased. The viewing area means an area where a video can be stereoscopically viewed when the liquid crystal panel 1 is seen from the front of the liquid crystal panel 1.

On the other hand, in the stereo imaging manner, parallax images for the right eye are displayed on four pixels among the nine pixels corresponding to the convex portions and parallax images for the left eye are displayed on the other five pixels. The parallax images for the left eye and the right eye are images of the subject viewed respectively from a viewpoint on the left side and a viewpoint on the right side of two viewpoints arranged in the horizontal direction. The viewer can stereoscopically view a video by seeing the parallax images for the left eye with his left eye and seeing the parallax images for the right eye with his right eye through the lenticular lens 2. According to the stereo imaging manner, feeling of three-dimensionality of a displayed video is more easily obtained than the integral imaging manner. However, a viewing area is narrower than that in the integral imaging manner.

The liquid crystal panel 1 can also display the same image on the nine pixels corresponding to the convex portions and display a two-dimensional image.

In this embodiment, the viewing area can be variably controlled according to a relative positional relation between the convex portions of the lenticular lens 2 and displayed parallax images, i.e., what kind of parallax images are displayed on the nine pixels corresponding to the convex portions. The control of the viewing area is explained below taking the integral imaging manner as an example.

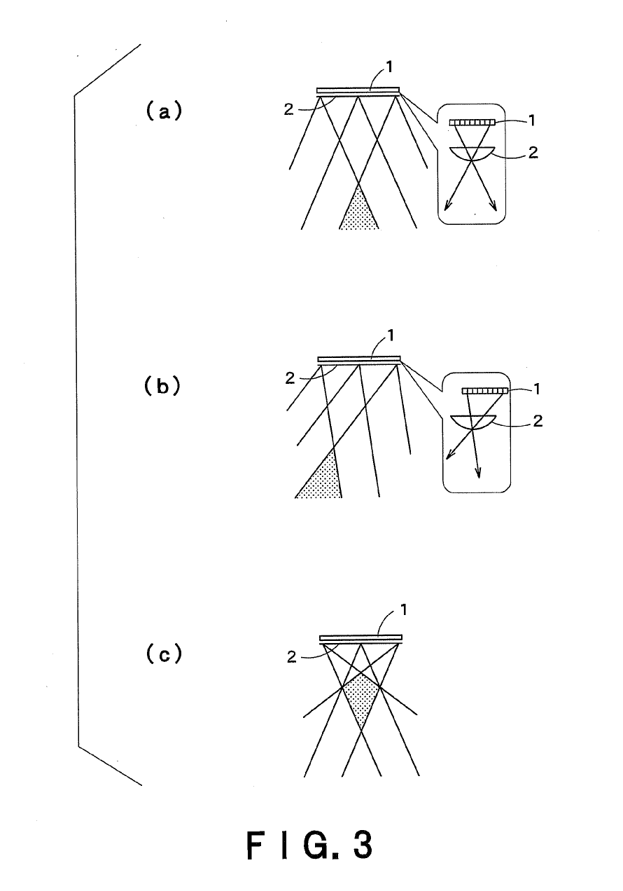

FIG. 3 is a diagram of a part of the liquid crystal panel 1 and the lenticular lens 2 viewed from above. A hatched area in the figure indicates the viewing area. The viewer can stereoscopically view a video when the viewer sees the liquid crystal panel 1 from the viewing area. Other areas are areas where a pseudoscopic image and crosstalk occur and areas where it is difficult to stereoscopically view a video.

FIG. 3 shows a relative positional relation between the liquid crystal panel 1 and the lenticular lens 2, more specifically, a state in which the viewing area changes according to a distance between the liquid crystal panel 1 and the lenticular lens 2 or a deviation amount in the horizontal direction between the liquid crystal panel 1 and the lenticular lens 2.

Actually, the lenticular lens 2 is stuck to the liquid crystal panel 1 while being highly accurately aligned with the liquid crystal panel 1. Therefore, it is difficult to physically change relative positions of the liquid crystal panel 1 and the lenticular lens 2.

Therefore, in this embodiment, display positions of the first to ninth parallax images displayed on the pixels of the liquid crystal panel 1 are shifted to apparently change a relative positional relation between the liquid crystal panel 1 and the lenticular lens 2 to thereby perform adjustment of the viewing area.

For example, compared with a case in which the first to ninth parallax images are respectively displayed on the nine pixels corresponding to the convex portions (FIG. 3(a)), when the parallax images are shifted to the right side as a whole and displayed (FIG. 3(b)), the viewing area moves to the left side.

Conversely, when the parallax images are shifted to the left side as a whole and displayed, the viewing area moves to the right side.

When the parallax images are not shifted near the center in the horizontal direction and the parallax images are more largely shifted to the outer side and displayed further on the outer side of the liquid crystal panel 1 (FIG. 3(c)), the viewing area moves in a direction in which the viewing area approaches the liquid crystal panel 1. Further a pixel between a parallax image to be shifted and a parallax image not to be shifted and a pixel between parallax images having different shift amounts only have to be appropriately interpolated according to pixels around the pixels. Conversely to FIG. 3(c), when the parallax images are not shifted near the center in the horizontal direction and the parallax images are more largely shifted to the center side and displayed further on the outer side of the liquid crystal panel 1, the viewing area moves in a direction in which the viewing area is away from the liquid crystal panel 1.

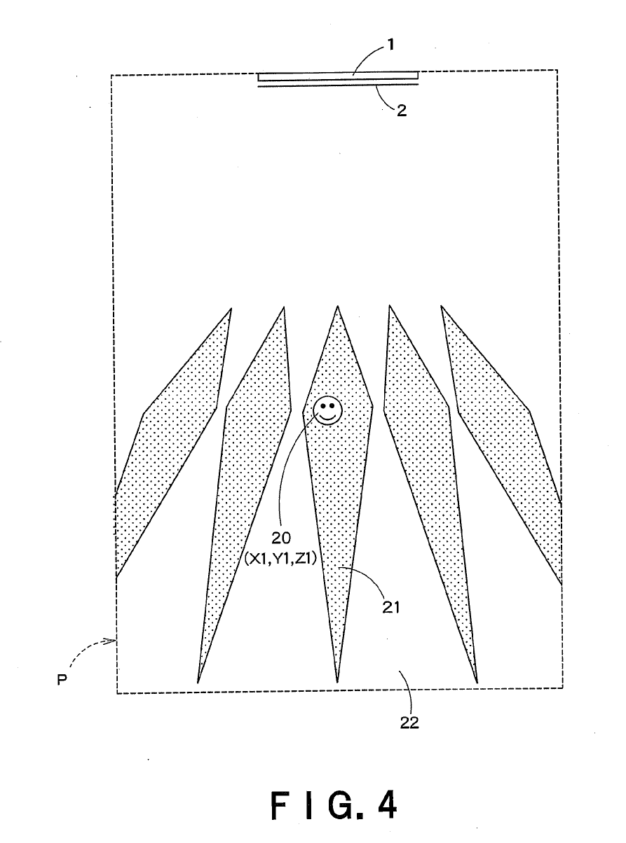

By shifting and displaying all or a part of the parallax images in this way, it is possible to move the viewing area in the left right direction or the front back direction with respect to the liquid crystal panel 1. In FIG. 3, only one viewing area is shown to simplify the explanation. However, actually, as shown in FIG. 4, plural viewing areas 21 are present in the view area P and move in association with one another. The viewing area is controlled by the controller 10 shown in FIG. 2 explained later. Further a view area other than the viewing areas 21 is a pseudoscopic image area 22 where it is difficult to see a satisfactory stereoscopic video because of occurrence of a pseudoscopic image, crosstalk, or the like.

Referring back to FIG. 1, the components of the video processing apparatus 100 are explained.

The camera 3 is attached near the center in a lower part of the liquid crystal panel 1 at a predetermined angle of elevation and photographs a predetermined range in the front of the liquid crystal panel 1. A photographed video is supplied to the controller 10 and used to detect information concerning the viewer such as the position, the face, and the like of the viewer. The camera 3 may photograph either a moving image or a still image.

The light receiver 4 is provided, for example, on the left side in a lower part of the liquid crystal panel 1. The light receiver 4 receives an infrared ray signal transmitted from a remote controller used by the viewer. The infrared ray signal includes a signal indicating, for example, whether a stereoscopic video is displayed or a two-dimensional video is displayed, which of the integral imaging manner and the stereo imaging manner is adopted when the stereoscopic video is displayed, and whether control of the viewing area is performed.

Next, details of the components of the controller 10 are explained. As shown in FIG. 2, the controller 10 includes a tuner decoder 11, a parallax image converter 12, a viewer detector 13, a viewing area information calculator 14, an image adjuster 15, a display manner selector 16, and a storage 17. The controller 10 is implemented as, for example, one IC (Integrated Circuit) and arranged on the rear side of the liquid crystal panel 1. It goes without saying that a part of the controller 10 is implemented as software.

The tuner decoder (a receiver) 11 receives and tunes an input broadcast wave and decodes an encoded video signal. When a signal of a data broadcast such as an electronic program guide (EPG) is superimposed on the broadcast wave, the tuner decoder 11 extracts the signal. Alternatively, the tuner decoder 11 receives, rather than the broadcast wave, an encoded video signal from a video output apparatus such as an optical disk player or a personal computer and decodes the video signal. The decoded signal is also referred to as baseband video signal and is supplied to the parallax image converter 12. Note that when the video display apparatus 100 does not receive a broadcast wave and solely displays a video signal received from the video output apparatus, a decoder simply having a decoding function may be provided as a receiver instead of the tuner decoder 11.

The video signal received by the tuner decoder 11 may be a two-dimensional video signal or may be a three-dimensional video signal including images for the left eye and the right eye (i.e., two parallax images). Examples of the latter include a video signal by a frame packing (FP), side-by-side (SBS), top-and-bottom (TAB) manner, or the like. The video signal may be a three-dimensional video signal including three or more parallax images.

The tuner decoder 11 reads a flag indicating a content type included in the baseband video signal. This makes it possible to discriminate a content type of an input video signal.

The parallax image converter 12 converts the baseband video signal into a desired video signal according to a video display manner selected by a display manner selector 16 explained later. In order to stereoscopically display a video, the parallax image converter 12 converts the baseband video signal into plural parallax image signals and supplies the parallax image signals to the image adjuster 15. When the selected video display manner is a two-dimensional video display manner (hereinafter simply referred to as “2D manner”), the parallax image converter 12 directly supplies a video signal of a 2D video content to the image adjuster 15.

Processing content of the parallax image converter 12 is different according to which of the integral imaging matter and the stereo imaging manner is adopted. The processing content of the parallax image converter 12 is different according to whether the baseband video signal is a two-dimensional video signal or a three-dimensional video signal.

When the stereo imaging manner is adopted, the parallax image converter 12 generates parallax image signals for the left eye and the right eye respectively corresponding to the parallax images for the left eye and the right eye. More specifically, the parallax image converter 12 generates the parallax image signals as explained below.

When the stereo imaging manner is adopted and a three-dimensional video signal including images for the left eye and the right eye is input, the parallax image converter 12 generates parallax image signals for the left eye and the right eye that can be displayed on the liquid crystal panel 1. When a three-dimensional video signal including three or more images is input, the parallax image converter 12 generates parallax image signals for the left eye and the right eye using, for example, arbitrary two of the three images.

In contrast, when the stereo imaging manner is adopted and a two-dimensional video signal not including parallax information is input, the parallax image converter 12 generates parallax image signals for the left eye and the right eye on the basis of depth values of pixels in the video signal. The depth value is a value indicating to which degree the pixels are displayed to be seen in the front or the depth with respect to the liquid crystal panel 1. The depth value may be added to the video signal in advance or may be generated by performing motion detection, composition identification, human face detection, and the like on the basis of characteristics of the video signal. In the parallax image for the left eye, a pixel seen in the front needs to be displayed to be shifted further to the right side than a pixel seen in the depth. Therefore, the parallax image converter 12 performs processing for shifting the pixel seen in the front in the video signal to the right side and generates a parallax image signal for the left eye. A shift amount is set larger as the depth value is larger.

On the other hand, when the integral imaging manner is adopted, the parallax image converter 12 generates first to ninth parallax image signals respectively corresponding to the first to ninth parallax images. More specifically, the parallax image converter 12 generates the first to ninth parallax image signals as explained below.

When the integral imaging manner is adopted and a two-dimensional video signal or a three-dimensional video signal including images having eight or less parallaxes is input, the parallax image converter 12 generates the first to ninth parallax image signals on the basis of depth information same as that for generating the parallax image signals for the left eye and the right eye from the two-dimensional video signal.

When the integral imaging manner is adopted and a three-dimensional video signal including images having nine parallaxes is input, the parallax image converter 12 generates the first to ninth parallax image signals using the video signal.

The viewer detector 13 detects viewers using a video photographed by the camera 3. More specifically, the viewer detector 13 performs face recognition using the video photographed by the camera 3 and acquires information concerning the viewers (e.g., face information and position information of the viewers). Since the viewer detector 13 can track the viewers even if the viewers move, the viewer detector 13 can also grasp a viewing time for each user.

The viewer detector 13 supplies the number of viewers to the display manner selector 16 and supplies the position information of the viewers to the viewing area information calculator 14.

The position information of the viewer is represented as, for example, a position on an X axis (in the horizontal direction), a Y axis (in the vertical direction), and a Z axis (a direction orthogonal to the liquid crystal panel 1) with the origin set in the center of the liquid crystal panel 1. The position of a viewer 20 shown in FIG. 4 is represented by a coordinate (X1, Y1, Z1). More specifically, first, the viewer detector 13 detects a face from a video photographed by the camera 3 to thereby recognize the viewer. Subsequently, the viewer detector 13 calculates a position (X1, Y1) on the X axis and the Y axis from the position of the viewer in the video and calculates a position (Z1) on the Z axis from the size of the face. When there are plural viewers, the viewer detector 13 may detect a predetermined number of viewers, for example, ten viewers. In this case, when the number of detected faces is larger than ten, for example, the viewer detector 13 detects positions of the ten viewers in order from a position closest to the liquid crystal panel 1, i.e., a smallest position on the Z axis.

The viewing area information calculator 14 calculates a control parameter for setting a viewing area in which the viewer is set. The control parameter is, for example, an amount for shifting the parallax images explained with reference to FIG. 3 and is one parameter or a combination of plural parameters. The viewing area information calculator 14 supplies the calculated control parameter to the image adjuster 15.

More specifically, in order to set a desired viewing area, the viewing area information calculator 14 uses a viewing area database that associates the control parameter and a viewing area set by the control parameter. The viewing area database is stored in the storage 17 in advance. The viewing area information calculator 14 finds, by searching through the viewing area database, a viewing area in which the selected viewer can be included.

In order to control the viewing area, after performing adjustment for shifting and interpolating a parallax image signal according to the calculated control parameter, the image adjuster (a viewing area controller) 15 supplies the parallax image signal to the liquid crystal panel 1. The liquid crystal panel 1 displays an image corresponding to the adjusted parallax image signal.

The display manner selector 16 selects one video display manner out of plural video display manners and supplies the selected video display manner to the parallax image converter 12. The video display manners include a 2D manner for displaying a two-dimensional video, a stereo imaging manner for displaying a stereoscopic video including two parallax images for the right eye and the left eye, and an integral imaging manner for displaying a stereoscopic video including three or more parallax images.

The display manner selector 16 may select, referring to setting of a 3D viewing mode, a video display manner on the basis of content of the setting. The 3D viewing mode is set from a setting menu by the user in order to switch a 3D display manner. The 3D viewing mode is set to the stereo imaging manner or the integral imaging manner (direct stereo setting auto/off). A button for selecting the stereo imaging manner and a button for selecting the integral imaging manner may be provided in a remote controller and a viewer may depress any one of the buttons to thereby set the 3D viewing mode.

The display manner selector 16 may be supplied with information concerning a content type of an input video signal from the tuner decoder 11 and select a video display manner on the basis of the content type.

The storage 17 is a nonvolatile memory such as a flash memory. The storage 17 stores setting of the 3D viewing mode besides a viewing area database. The display manner selector 16 reads out the setting of the 3D viewing mode from the storage 17. The storage 17 may be provided on the outside of the controller 10.

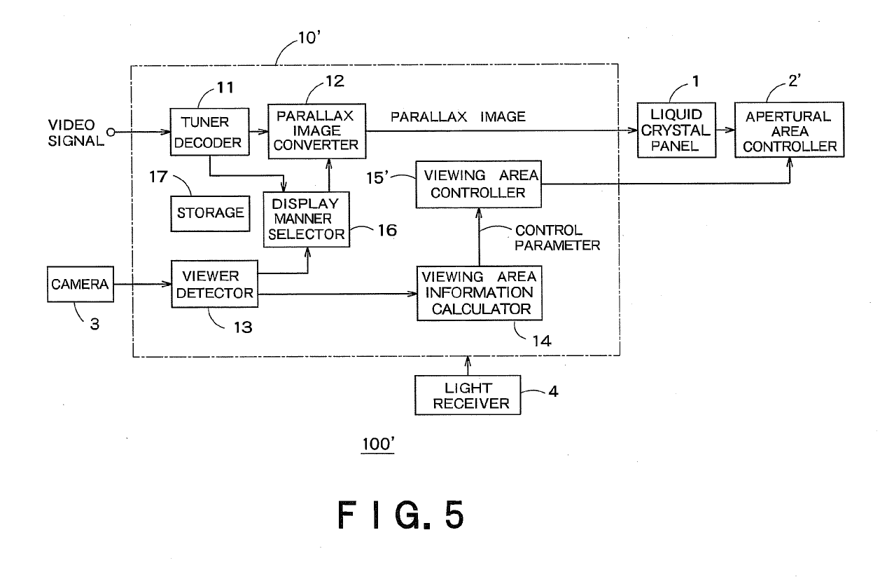

The configuration of the video processing apparatus 100 is explained above. In this embodiment, the example in which the lenticular lens 2 is used and the viewing area is controlled by shifting the parallax image is explained. However, the viewing area may be controlled by other methods. For example, a parallax barrier may be provided as an apertural area controller 2′ instead of the lenticular lens 2. FIG. 5 is a block diagram showing a schematic configuration of a video processing apparatus 100′ according to a modification of this embodiment shown in FIG. 2. As shown in the figure, a controller 10′ of the video processing apparatus 100′ includes a viewing area controller 15′ instead of the image adjuster 15. The viewing area controller 15′ controls an apertural area controller 2′ according to a control parameter calculated by the viewing area information calculator 14. In the case of this modification, the control parameter is a distance between the liquid crystal panel 1 and the apertural area controller 2′, a deviation amount in the horizontal direction between the liquid crystal panel 1 and the apertural area controller 2′, and the like.

In this modification, an output direction of a parallax image displayed on the liquid crystal panel 1 is controlled by the apertural area controller 2′, whereby the viewing area is controlled. In this way, the apertural area controller 2′ may be controlled by the viewing area controller 15′ without performing processing for shifting the parallax image.

### First Embodiment

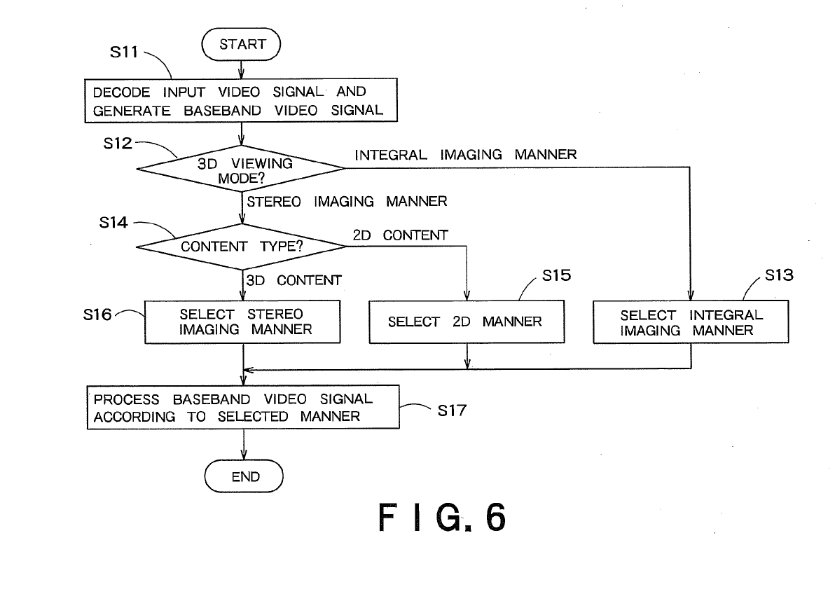

Next, a video processing method by the video processing apparatus 100 (100′) configured as explained above is explained with reference to the flowchart of FIG. 6.

(1) The tuner decoder 11 decodes an input video signal and generates a baseband video signal (step S11).

(2) The display manner selector 16 refers to the setting of the 3D viewing mode stored in the storage 17 (step S12). When the 3D viewing mode is set to the integral imaging manner, the display manner selector 16 selects the integral imaging manner (step S13). When the 3D viewing mode is set to the stereo imaging manner, processing proceeds to step S14.

(3) The tuner decoder 11 reads a flag indicating a content type included in the baseband video signal (step S14). As a result of discrimination of the content type of the input video signal, if the content type is 2D video content, the display manner selector 16 selects the 2D manner (step S15). On the other hand, if the content type is 3D content, the display manner selector 16 selects the stereo imaging manner (step S16).

(4) The parallax image converter 12 processes the baseband video signal on the basis of the display manner selected by the display manner selector 16 (step S17). Specifically, when the stereo imaging manner is selected, the parallax image converter 12 converts the baseband video signal into two parallax image signals for the left eye and the right eye. When the 2D manner is selected, the parallax image converter 12 directly outputs the baseband video signal of a two-dimensional video. When the integral imaging manner is selected, the parallax image converter 12 converts the baseband video signal into three or more parallax image signals.

According to the first embodiment, the stereo imaging manner or the integral imaging manner is selected according to the 3D viewing mode. Further, the stereo imaging manner or the 2D manner is selected according to the content type. In the case of the integral imaging manner, since a viewing area is large, a large number of people present in front of the video processing apparatus can enjoy a stereoscopic video. On the other hand, in the case of the stereo imaging manner, since a viewer can directly view left and right parallax videos included in the 3D content, the viewer can enjoy a stereoscopic video excellent in a stereoscopic effect.

### (First Modification)

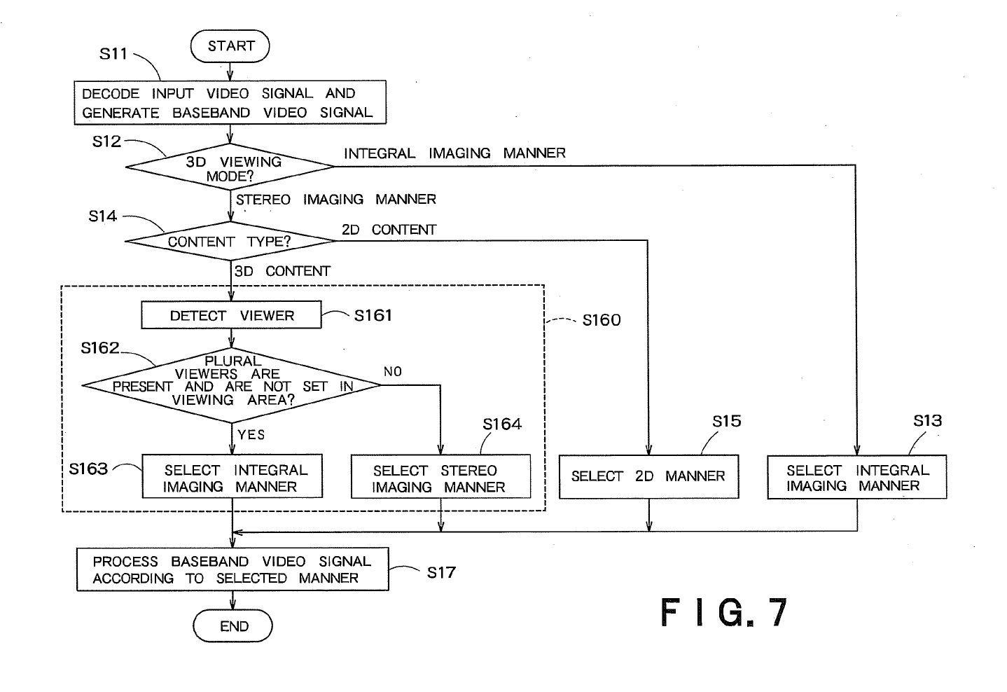

Next, a video processing method according to a first modification of the first embodiment is explained with reference to a flowchart of FIG. 7. Since the 3D content including the two parallax videos is excellent in the stereoscopic effect but has a small viewing area as explained above, when the number of viewers is large, it is difficult for all the viewers to view a stereoscopic video. Therefore, in this modification, even when the 3D viewing mode is set to the stereo imaging manner, the stereo imaging manner is switched to the integral imaging manner according to, for example, the number of viewers. Steps other than step S160 are the same as the steps in the first embodiment. Therefore, only steps in step S160 are explained in detail below.

(1) The viewer detector 13 detects a viewer using a video photographed by the camera 3 (step S161).

(2) The display manner selector 16 determines whether plural viewers are present and are not set in a viewing area (step S162). When plural viewers are present and are not set in the viewing area, the display manner selector 16 selects the integral imaging manner (step S163). Otherwise, the display manner selector 16 selects the stereo imaging manner (step S164).

According to the first modification, the integral imaging manner is selected when plural viewers are present and are not set in the viewing area. Therefore, the plural viewers can enjoy a stereoscopic video.

### (Second Modification)

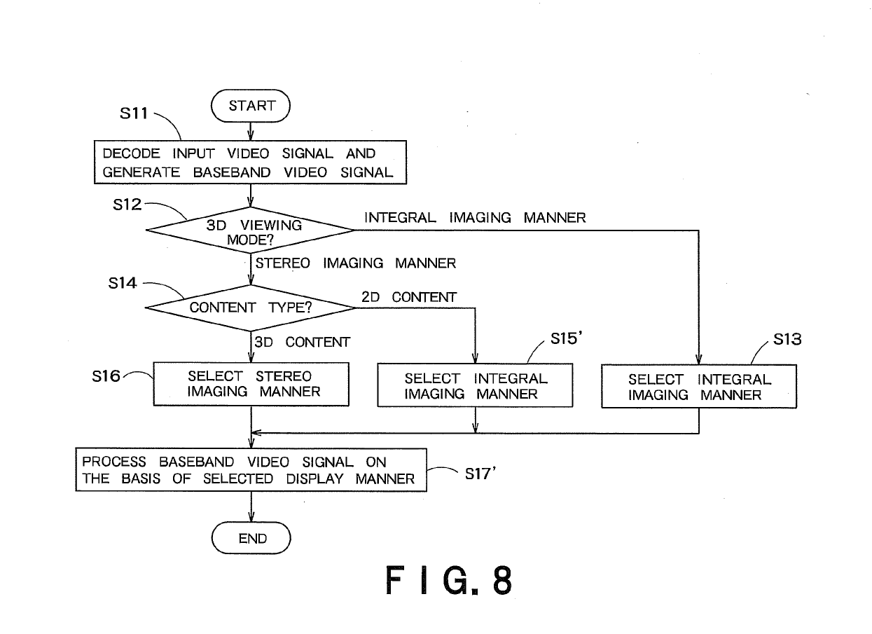

Next, a video processing method according to a second modification of the first embodiment is explained with reference to a flowchart of FIG. 8. In the first embodiment, in the case of the 2D video content, the two-dimensional video is directly displayed. However, in this modification, the two-dimensional video is converted into a stereoscopic video (2D to 3D conversion) and the stereoscopic video is displayed. Further, since steps other than step S15′ and step S17′ are the same as the steps in the first embodiment, detailed explanation of the steps is omitted.

(1) When the content type is two-dimensional video content (2D content), the display manner selector 16 selects the integral imaging manner (step S15′).

(2) When the integral imaging manner is selected because the content type is the 2D content, the parallax image converter 12 performs the 2D to 3D conversion of the two-dimensional video signal and converts the baseband video signal of the 2D video content into a signal of a stereoscopic video including three or more parallax images (step S17′). The baseband video signal of the 2D video content may be converted into a signal of a stereoscopic video including two parallax images for the right eye and the left eye.

According to the second modification, even in the case of the 2D video content, the 2D to 3D conversion is performed to display a stereoscopic video in the integral imaging manner. Therefore, the viewer can enjoy the stereoscopic video.

### Second Embodiment

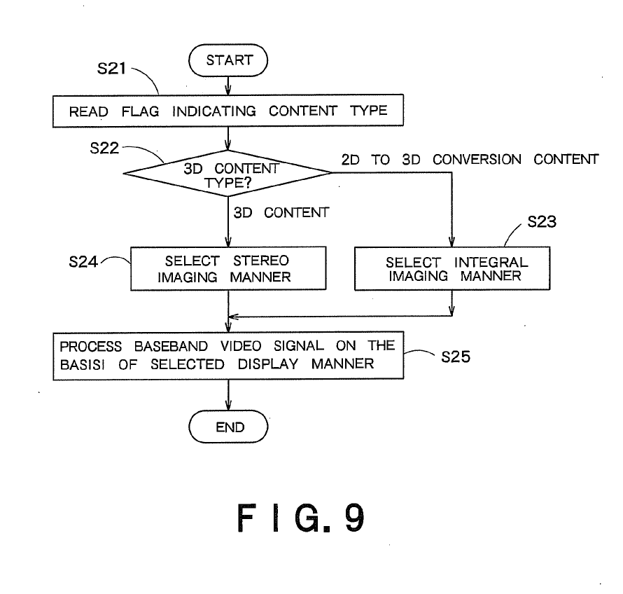

In a second embodiment, a display manner is selected on the basis of a content type of a stereoscopic video (a 3D content type). A video processing method according to this embodiment is explained below with reference to a flowchart of FIG. 9.

(1) The tuner decoder 11 decodes an encoded input video signal and generates a baseband video signal. Thereafter, the tuner decoder 11 reads a flag indicating a 3D content type included in the baseband video signal (step S21).

(2) As a result of discrimination of the 3D content type (step S22), in the case of 2D to 3D conversion content, the display manner selector 16 selects the integral imaging manner (step S23). In the case of 3D content other than the 2D to 3D conversion content, the display manner selector 16 selects the stereo imaging manner (step S24). The 2D to 3D conversion content means stereoscopic video content converted from a two-dimensional video into a stereoscopic video through 2D to 3D conversion.

Even in the case of the 3D content, when plural viewers are present and are not set in a viewing area, the integral imaging manner may be selected. In other words, step S160 in the first modification may be performed instead of step S24.

(3) The parallax image converter 12 processes the baseband video signal on the basis of the display manner selected by the display manner selector 16 (step S25). Specifically, when the stereo imaging manner is selected, the parallax image converter 12 converts the baseband video signal into two parallax image signals for the left eye and the right eye. When the integral imaging manner is selected, the parallax image converter 12 converts the baseband video signal into three or more parallax image signals.

According to the second embodiment, an appropriate display manner is selected, according to a 3D content type, from the stereo imaging manner that gives priority to a stereoscopic effect of a stereoscopic video and the integral imaging manner that gives priority to the extent of a viewing area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video processing apparatus comprising:
a receiver configured to decode an encoded input video signal and generate a baseband video signal;
a display mode selector configured to select a display mode from a plurality of display modes comprising a stereo imaging mode and an integral imaging mode; and
a parallax image converter configured to
convert, when the stereo imaging mode is selected, the baseband video signal into two parallax image signals for a left eye and a right eye and
convert, when the integral imaging mode is selected, the baseband video signal into three or more parallax image signals.

2. The video processing apparatus of claim 1, wherein the display mode selector is configured to
select the stereo imaging mode when a 3D viewing setting is set to the stereo imaging mode and
select the integral imaging mode when the 3D viewing setting is set to the integral imaging mode.

3. The video processing apparatus of claim 2, wherein
the receiver is configured to read a flag indicating a content type included in the baseband video signal,
the display mode selector is configured to select a two-dimensional video display mode instead of the stereo imaging mode when the 3D viewing setting is set to the stereo imaging mode and the content type is two-dimensional video content, and
the parallax image converter is configured to directly output the baseband video signal of a two-dimensional video without converting the baseband video signal into two parallax image signals for the left eye and the right eye when the two-dimensional video display mode is selected.

4. The video processing apparatus of claim 2, further comprising a viewer detector configured to detect a viewer using a video photographed by a camera, wherein
the receiver is configured to read a flag indicating a content type included in the baseband video signal, and
the display mode selector is configured to select the integral imaging mode instead of the stereo imaging mode when the 3D viewing setting is set to the stereo imaging mode and the content type is stereoscopic video content and when a plurality of the viewers are present and are not set in a viewing area.

5. The video processing apparatus of claim 2, wherein
the receiver is configured to read a flag indicating a content type included in the baseband video signal,
the display mode selector is configured to select the integral imaging mode instead of the stereo imaging mode when the 3D viewing setting is set to the stereo imaging mode and the content type is two-dimensional video content, and
the parallax image converter is configured to convert the baseband video signal of the two-dimensional video content into a signal of a stereoscopic video including three or more parallax images when the integral imaging mode is selected by the display mode selector.

6. The video processing apparatus of claim 1, wherein
the receiver is configured to read a flag indicating a 3D content type included in the baseband video signal, and
the display mode selector is configured to
select the integral imaging mode when the 3D content type is 2D to 3D conversion content converted from a two-dimensional video into a stereoscopic video and
select the stereo imaging mode when the 3D content type is a stereoscopic video content other than the 2D to 3D conversion content.

7. A video processing method comprising:
decoding an encoded input video signal and generating a baseband video signal;
selecting one display mode from a plurality of display modes comprising a stereo imaging mode and an integral imaging mode; and
when the stereo imaging mode is selected, converting the baseband video signal into two parallax image signals for a left eye and a right eye, and
when the integral imaging mode is selected, converting the baseband video signal into three or more parallax image signals.

8. The video processing method of claim 7, further comprising
selecting the stereo imaging mode when a 3D viewing setting is set to the stereo imaging mode and
selecting the integral imaging mode when the 3D viewing setting is set to the integral imaging mode.

9. The video processing method of claim 8, further comprising
reading a flag indicating a content type included in the baseband video signal after generating the baseband video signal and before selecting the display mode;
selecting a two-dimensional video display mode instead of the stereo imaging mode when the 3D viewing setting is set to the stereo imaging mode and the content type is two-dimensional video content; and
directly outputting the baseband video signal of a two-dimensional video without converting the baseband video signal into two parallax image signals for the left eye and the right eye.

10. The video processing method of claim 8, further comprising:
reading a flag indicating a content type included in the baseband video signal after generating the baseband video signal and before selecting the display mode; and
selecting the integral imaging mode instead of the stereo imaging mode when the 3D viewing setting is set to the stereo imaging mode and the content type is stereoscopic video content and when a plurality of the viewers are present and are not set in a viewing area.

11. The video processing method of claim 8, further comprising:
reading a flag indicating a content type included in the baseband video signal after generating the baseband video signal and before selecting the display mode;
selecting the integral imaging mode instead of the stereo imaging mode when the content type is two-dimensional video content; and
converting the baseband video signal of the two-dimensional video content into a signal of a stereoscopic video including three or more parallax images.

12. The video processing method of claim 7, further comprising:
reading a flag indicating a 3D content type included in the baseband video signal after generating the baseband video signal; and
selecting the integral imaging mode when the 3D content type is 2D to 3D conversion content converted from a two-dimensional video into a stereoscopic video and selecting the stereo imaging mode when the 3D content type is a stereoscopic video content other than the 2D to 3D conversion content.
